(19) United States
(12) Patent Application Publication
(10) Pub. No.: US 2024/0273688 A1
(43) Pub. Date: Aug. 15, 2024

(54) METHOD, APPARATUS, DEVICE AND STORAGE MEDIUM FOR IMAGE PROCESSING

(71) Applicant: Beijing Zitiao Network Technology Co., Ltd., Beijing (CN)

(72) Inventors: Lijie Liu, Beijing (CN); Miao Hua, Beijing (CN)

(21) Appl. No.: 18/568,745

(22) PCT Filed: May 9, 2022
(86) PCT No.: PCT/CN2022/091681

§ 371 Date: Dec. 8, 2023

(30) Foreign Application Priority Data
Jun. 10, 2021 (CN) 202110646606.2

(51) Int. Cl. G06T 5/77; G06T 3/4038; G06T 5/50; G06T 13/80; G06V 40/16

(52) U.S. Cl. CPC G06T 5/77; G06T 3/4038; G06T 5/50; G06T 13/80; G06V 40/171; G06T 2207/20081; G06T 2207/30201

(57) ABSTRACT

The disclosure relates to a method, apparatus, device and storage medium for image processing. The method includes performing a smearing process on a target facial organ in a facial image to be process by a pretrained smearing model, to obtain a smeared facial image corresponding to the facial image to be processed. By performing the smearing process on the target facial organ in the facial image to be processed to generate the corresponding smeared facial image, it can improve the interest of the image.

### CROSS-REFERENCE TO RELATED APPLICATIONS

The present application claims priority to Chinese Patent Application No. 202110646606.2 filed on Jun. 10, 2021 and entitled “method, apparatus, device and storage medium for image processing”, the entirety of which is incorporated herein by reference.

### FIELDS

Embodiments of the present disclosure relates to the technical field of image processing, and particularly to a method, apparatus, device and storage medium for image processing.

### BACKGROUND

In related technologies, users may record their lives through videos, photos, and the like, and upload them to video applications for other video consumers to view. However, with the development of video applications, simple video or picture sharing can no longer meet the growing needs of users. Therefore, how to process videos and images to improve the interest of videos and images is a technical problem that needs to be solved urgently.

### SUMMARY

In order to solve or at least in part solve the above technical problems, the present disclosure provides, in an aspect, a method of image processing, including: obtaining a facial image to be processed: and performing a smearing process to a target facial organ in the facial image to be processed based on a pre-trained smearing model to obtain a smeared facial image corresponding to the facial image to be processed, wherein the smearing model is training based on a first facial image obtained without smearing the target facial organ and a second facial image obtained by smearing the target facial organ in the first facial image, wherein the second facial image is generated based on a predetermined image generating model, the image generating model being trained based on a target texture image and a target facial image.

Optionally, the target texture image comprises a skin image obtained by performing an expanding process on a skin image in a target area in the first facial image, the target area comprising a forehead area.

Optionally, the forehead area is determined based on a key point of an eyebrow and a key point of a forehead contour in the first facial image.

Optionally, the target facial image is a mask of the target facial organ determined based on the target facial organ.

Optionally, the mask of the target facial organ is determined based on a key point of the target facial organ in the first facial image.

Optionally, performing an expanding process on a skin image in the target area includes: performing a mirror reflection process on the skin image in the target area: and performing a stitching process on a reflected image obtained by the mirror reflection process and the skin image in the target area.

Optionally, performing an expanding process on a skin image in the target area includes: performing a replication process on the skin image in the target area: and performing a stitching processing on a plurality of replicated images obtained from the replication process.

Optionally, after obtaining the facial image to be processed, the method further includes: extracting a first organ image corresponding to the target facial organ in the facial image to be processed: adjusting a shape and/or a size of the target facial organ in the first organ image to obtain a second organ image, wherein, after performing a smearing process to a target facial organ in the facial image to be processed based on a pre-trained smearing model to obtain a smeared facial image corresponding to the facial image to be processed, the method further includes: adding the second organ image to the smeared facial image.

Optionally, after performing a smearing process to a target facial organ in the facial image to be processed based on a pre-trained smearing model to obtain a smeared facial image corresponding to the facial image to be processed, the method further includes: transferring a predetermined animation to the smeared facial image to obtain a dynamic image.

In another aspect, the present disclosure provides an apparatus for image processing comprising: an image obtaining unit configured to obtain a facial image to be processed: and a smearing processing unit configured to perform a smearing process to a target facial organ in the facial image to be processed based on a pre-trained smearing model to obtain a smeared facial image corresponding to the facial image to be processed, wherein the smearing model is training based on a first facial image obtained without smearing the target facial organ and a second facial image obtained by smearing the target facial organ in the first facial image, wherein the second facial image is generated based on a predetermined image generating model, the image generating model being trained based on a target texture image and a target facial image.

Optionally, the target texture image comprises a skin image being obtained by performing an expanding process on a skin image in a target area in the first facial image, and the target area comprises a forehead area.

Optionally, the forehead area is determined based on a key point of an eyebrow and a key point of a forehead contour in the first facial image.

Optionally, the target facial image is a mask of the target facial organ determined based on the target facial organ.

Optionally, the mask of the target facial organ is determined based on a key point of the target facial organ in the first facial image.

Optionally, performing an expanding process on a skin image in the target area includes: performing a mirror reflection process on the skin image in the target area: and performing a stitching process on a reflected image obtained by the mirror reflection process and the skin image in the target area.

Optionally, performing an expanding process on a skin image in the target area includes: performing a replication process on the skin image in the target area: and performing a stitching processing on a plurality of replicated images obtained from the replication process.

Optionally, the apparatus further comprises: an organ extracting unit, configured to extract a first organ image corresponding to the target facial organ in the facial image to be processed: an organ image adjusting unit, configured to adjust a shape and/or a size of the target facial organ in the first organ image to obtain a second organ image: and a first image addition unit, configured to add the second organ image to the smeared facial image.

Optionally, the apparatus further comprises: a second image addition unit, configured to transfer a predetermined animation to the smeared facial image to obtain a dynamic image.

In a further aspect, the present disclosure provides an electronic device comprising a memory and a processor, wherein a computer program is stored in the memory, and when the computer program is executed by the processor, any of the method described above is implemented.

In a further aspect, the present disclosure provides a computer-readable storage medium in which a computer program is stored, and when the computer program is executed by the processor, any of the method described above is implemented.

### BRIEF DESCRIPTION OF THE DRAWINGS

The accompanying drawings herein are incorporated into the specification and form part of this specification, show embodiments that are consistent with the present disclosure and are used together with the specification to explain the principles of the present disclosure.

In order to more clearly illustrate the technical solution in the embodiments of the present disclosure or the prior art, a brief description is presented below to the accompanying drawings used in the description of the embodiments or the prior art. It is obvious to those of ordinary skill in the art that other drawings can further be obtained from these drawings without creative effort.

FIG. 1 is a schematic flowchart of a method for image processing provided by an embodiment of the present disclosure :

FIG. 2 is a facial image to be processed provided by an embodiment of the present disclosure:

FIG. 3 is a schematic diagram of a smeared facial image provided by an embodiment of the present disclosure:

FIG. 4 is a facial image for training an image generating model provided by an embodiment of the present disclosure:

FIG. 5 is a flow chart of a method for image processing provided by other embodiments of the present disclosure:

FIG. 6 is a smeared facial image determined by steps S101-S105:

FIG. 7 is a flow chart of a method for image processing provided by several further embodiments of the present disclosure:

FIG. 8 is a structural diagram of an apparatus for image processing provided by an embodiment of the present disclosure: and

FIG. 9 is a structural diagram of an electronic device provided by an embodiment of the present embodiment.

### DETAILED DESCRIPTION

In order to more clearly understand the above objects, features and advantages of the present disclosure, the solution of the present disclosure will be further described below. It should be noted that the embodiments of the disclosure and features in the embodiments may be combined with each other without conflict.

Many specific details are set forth in the description below to facilitate a full understanding of the present disclosure, whereas the present disclosure may also be implemented in ways other than those described herein: obviously, the embodiments in the specification are only a portion rather than all of the embodiments of the present disclosure.

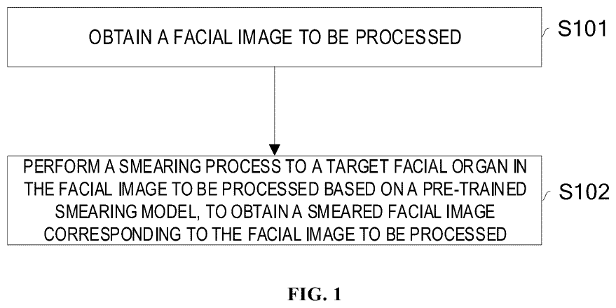

FIG. 1 is a flowchart of a method for image processing provided by an embodiment of the present disclosure. The method for facial image processing shown in FIG. 1 can be performed by an electronic device with image processing capability. The electronic device may be exemplarily understood as a device such as a mobile phone, tablet computer, desktop computer, all-in-one computers, etc.

As shown in FIG. 1, the method for image processing provided by an embodiment of the present disclosure include steps S101-S102.

At step S101, a facial image to be processed is obtained.

The facial image to be processed may be a facial image of a person or a facial image of an animal, and the present embodiment is not specifically limited.

In the present disclosure embodiments, the electronic device may obtain the facial image to be processed in a predetermined manner. In some embodiments, the predetermined manner may include shooting, downloading, or loading from local memory, etc. However, in other embodiments of the present disclosure, the predetermined manner may not be limited to shooting, downloading, and loading from local memory.

In some embodiments of the present disclosure, the facial image to be processed includes facial pixels of an object and other scene pixels. For example, in one example, the facial image to be processed may include an image of the upper body of the person and a background image.

At step S102, a smeared facial image corresponding to the facial image to be processed is obtained by performing a smearing process to a target facial organ in the facial image to be processed based on a pre-trained smearing model.

The smearing model is a model used for performing the smearing process to the target facial organ in the facial image to be processed, to change the pixel characteristic in an area within which the target facial organ is located.

After the facial image to be processed is input into the smearing model, the smearing model recognizes a pixel area of the target facial organ in the facial image to be processed, and smears the area where the target facial organ is located, so that the area where the target facial organ is located is smeared with a target texture.

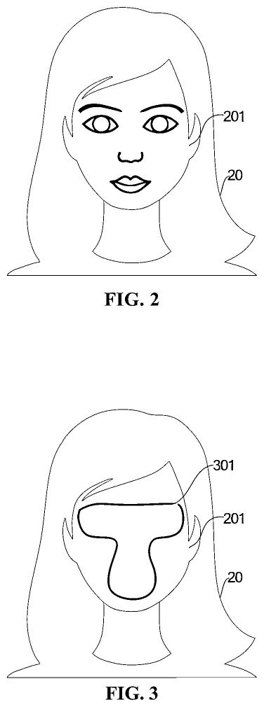

FIG. 2 is a facial image to be processed provided by an embodiment of the present disclosure. As shown in FIG. 2, the facial image to be processed is a facial image 201 of a person object 20. FIG. 3 is a schematic diagram of a smeared facial image provided by an embodiment of the present disclosure, and FIG. 3 is the smeared facial image obtained after being processed by the smearing model in FIG. 2. By comparing FIG. 2 and FIG. 3, the target facial organ used for smearing in some embodiments of the present disclosure may include eyebrows, eyes, nose and mouth. A mask containing eyebrows, eyes, nose and mouth may be determined based on key points of eyebrows, eyes, nose and mouth, namely T-shaped area 301 in FIG. 3. After the smearing process by the smearing model, the T-area 301 is smeared with the target texture.

According to the above description of the steps of the image processing method and the comparison between FIG. 2 and FIG. 3, the method for image processing provided in embodiments of the present disclosure uses the smearing model to process the facial image to be processed to obtain the smeared facial image. The image processing method embodied in the preceding steps S101 and S102 is integrated into a specific application program or software. After the application program or software is installed on the electronic device, the user's facial image may be smeared to obtain the smeared facial image, realizing the change of the face pixels of the image to be processed, and improving the interest of the image and user experience.

In embodiments of the present disclosure, the smearing model is a model trained based on a first facial image and a second facial image. The target facial organ in the first facial image is not smeared. The second facial image is the image obtained after smearing the target facial organ in the first facial image.

In embodiments of the present disclosure, the first facial image and the corresponding second facial image form a pair of sample images. A plurality of pairs of sample images may be used to train the smearing model herein. In order to train the smearing model, parameters of the smearing model are first randomly initialized. Then the pairs of sample images are input into the initialized smearing model, and the parameters of the smearing model are trained and adjusted. Finally, test images are used to test the smearing model after the parameter adjustment. If the test results show that the trained model meets predetermined accuracy requirements, then the training of the smearing model is completed.

In one embodiment of the present disclosure, a first facial image and a mask of a target facial organ may be input into a predetermined image generating model, from which a second facial image is generated for training the smearing model. Herein, the image generating model may be trained based on the target texture image and the target facial image.

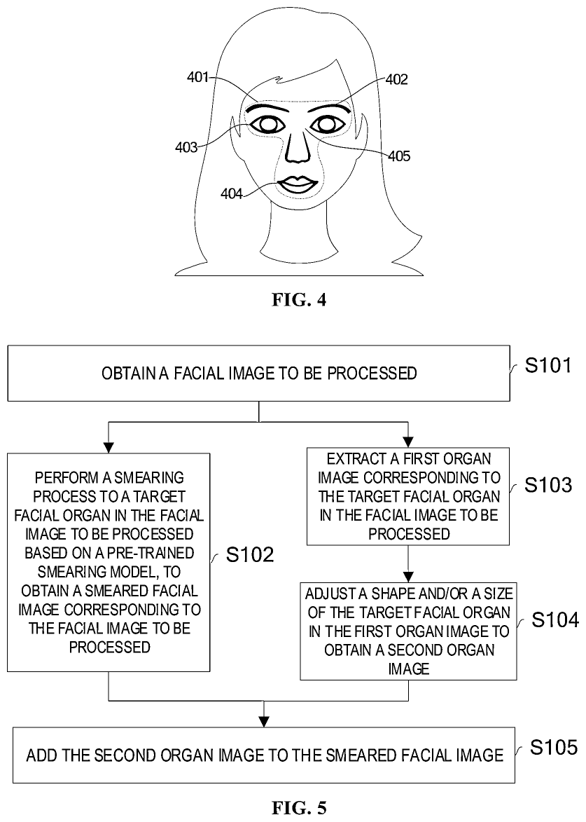

In embodiments of the present disclosure, the target facial image may be exemplarily understood as a mask of the target facial organ obtained based on the determination of the target facial organ. The mask of the target facial organ may be understood as an area whose shape matches that of the target facial organ. FIG. 4 is a facial image provided by an embodiment of the present disclosure for training an image generating model. As shown in FIG. 4, the dotted checkbox 401 is the area corresponding to the mask of the target facial organ.

In some embodiments of the present disclosure, the mask of the target facial organ may be determined based on key points of the target facial organ in the first facial image.

Still referring to FIG. 4, in the first facial image shown in FIG. 4, the target facial organs are exemplified as eyebrows, eyes, nose, and mouth. The key points identified based on these four target facial organs include at least eyebrow key 402, eye key 403, mouth key 404, and nose key 405. After determining the key points of the aforementioned target facial organs, the region 401 shown in the dotted line selection box may be determined based on the aforementioned key points, which is the region corresponding to the mask of the target facial organs.

In embodiments of the present disclosure, a target texture image refers to an image used to fill the mask of the target facial organ.

In some embodiments of the present disclosure, the target texture image may be a skin image. Specifically, the target texture image may be obtained by augmenting the skin image in the target area in the first facial image. In other embodiments of the present disclosure, the target texture image may also be a pre-selected image with other texture properties, such as a flesh-colored frosted image, which is only for the purpose of illustration and not unique here.

In some embodiments of the present disclosure, the target region of the first facial image may be the forehead region in the first facial image. By using the skin image of the forehead region to obtain the target texture image, the target texture image can be smoothly connected with the area outside the mask in the first facial image.

In other embodiments of the present disclosure, the target area of the first facial image may also be concretized to other areas of the first facial image. For example, in other embodiments, the target area may also be instantiated as a cheek area or a chin area. This is, of course, only for the purpose of illustration and not unique here.

In one embodiment of the present disclosure, the forehead area may be determined based on a key point of an eyebrow and a key point of a forehead contour in the first facial image.

The key point of eyebrow key may be understood as the key point at a junction of an upper edge of the eyebrow and the forehead area. The key point of the forehead contour may be understood as the key point where the forehead area meets the hairline.

Because the pixels at the junction of the eyebrow and forehead area are sharply contrasted, and the forehead contour is sharply contrasted with the hair area at the hairline junction, and the aforementioned junctions have specific curve features, in some embodiments, the key points of the eyebrow and forehead contour may be determined based on the pixel contrast and specific curve features.

In embodiments of the present disclosure, if the target area is the forehead area in the first facial image, the target texture image is obtained by an expanding processing based on the skin image of the forehead area. In the present embodiment, the methods of expanding the skin image of the forehead area to obtain the target texture image include at least the following.

In a first method, the skin image of the forehead area is processed by a mirror reflection process to obtain the reflected image, and then the reflected image obtained by the mirror reflection process is stitched with the skin image in the forehead area to obtain the target texture image.

In the mirror reflection processing of the skin image of the forehead area, the key points on the top of the two eyebrows may be used to determine the straight line as the mirror reflection surface to get the reflected image. Then, the reflected image and the original forehead image are stitched, and the gap area with non-skin features is excluded to get the target texture image.

In a second method, the skin image of the forehead area is replicated to get a plurality of replicated images. Then, the obtained plurality of replicated images is stitched, and the gap area with non-skin features is excluded to get the target texture image.

FIG. 5 is a flow chart of a method for image processing provided by other embodiments of the present disclosure. In other embodiments of the present disclosure, steps S103-S105 may be included after steps S101 above, as shown in FIG. 5. Only steps S103-S105 added to the image processing method are described here, and steps S101 and S102 may be described by reference to the above.

At step S103, a first organ image corresponding to the target facial organ in the facial image to be processed is extracted.

During the execution of step S103, a feature recognition algorithm may be used to determine the key point or edge area of the target facial organ. Then, a selected area containing the target facial organ is determined based on the key point or edge area, and an image area delimited by the selected area is taken as the corresponding image of the first organ.

At step S104, a shape and/or a size of the target facial organ in the first organ image is adjusted to obtain a second organ image.

At step S104, there are several approaches to adjust the shape and/or size of the target facial organ in the first organ image, as follows.

In a first approach, the target facial organ is enlarged or reduced. For example, if the target facial organ is the eye, and the eye in the first organ image is small, the eye in the first organ image may be enlarged to get the second organ image.

In a second approach, the shape of the target facial organ is adjusted. For example, if the target facial organ is the mouth, and a corner of the mouth are in a downward state, then the shape of the mouth in the image of the first organ may be adjusted, so that the corner of the mouth is changed from a downward state to an upward state, and the image of the second organ may be obtained.

It is to be noted that the aforementioned steps S103 and S104 are independent of steps S102, and steps S103-S104 may be performed in parallel with steps S102, or before or after steps S102.

At step S105, the second organ image is added to the smeared facial image.

The step S105 is performed after performing the steps S102 and S104. At step S105, a placement position of the second organ image may be determined based on a placement position of the first organ image, and then the second organ image may be added to the smeared facial image according to the above placement positions.

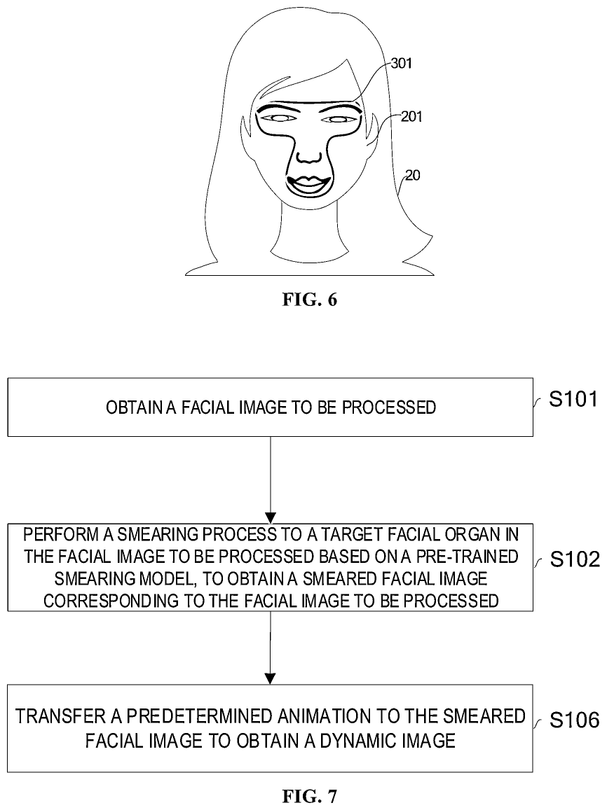

FIG. 6 is the smeared facial image determined by steps S101- S105. Comparing FIG. 2 and FIG. 6, in some embodiments of the present disclosure, the first organ image adjusted by the steps S103 and S104 is the eye image and the mouth image. Specifically, the eye in the eye image is reduced, and the mouth in the mouth image is raised to obtain the adjusted eye image and the adjusted mouth image. The adjusted eye image and adjusted mouth image are placed in the smeared facial image based on the positions of the original eye and mouth. A facial image with changed expression is obtained as shown in FIG. 6.

FIG. 7 is a flow chart of a method for image processing provided by further embodiments of the present disclosure. As shown in FIG. 7, in further embodiments of the present disclosure, the image processing method may include step S106 in addition to steps S101 and S102 described above. Step S106 is performed after step S102. Only step S106 added to the image processing method is described here. Steps S101 and S102 may be described by reference to the preceding paragraph.

At step S106, a predetermined animation is transferred to the smeared facial image to obtain a dynamic image.

The predetermined animation is a pre-selected animation with a facial expression action. For example, the predetermined animation may be a winking animation, a snorting animation, or an open mouth howling animation, but it is not limited to the animations listed here.

To transfer the predetermined animation to the smeared facial image, a position of the corresponding facial organ in the image to be processed is firstly determined based on a type of the predetermined animation, and then the predetermined animation is placed at the position of the corresponding facial organ. For example, if the predetermined animation is a blinking animation, this animation may be placed at the position of the eye corresponding to the facial image to get a dynamic image.

In embodiments of the present disclosure, the predetermined animation is transferred to the smeared facial image to obtain the dynamic image, so that the smeared facial image has a dynamic effect, which can further improve the interest of the smeared facial image and enhance the user experience.

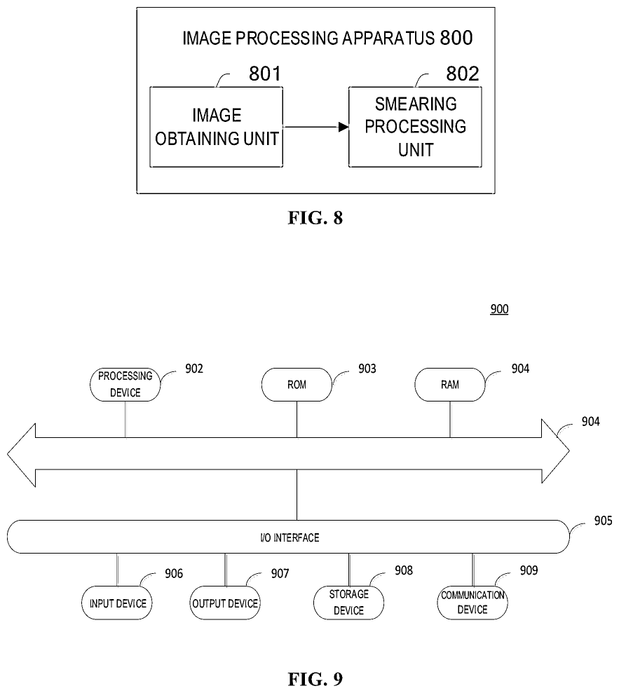

FIG. 8 is a structural schematic diagram of an apparatus for image processing provided in an embodiment of the present disclosure, which can be understood as the electronic device or part of the functional modules of the electronic device. As shown in FIG. 8, the processing device 800 comprises an image obtaining unit 801 and a smearing processing unit 802.

The image obtaining unit 801 is configured to obtain a facial image to be processed. The smearing processing unit 802 is configured to perform a smearing process to a target facial organ in the facial image to be processed based on a pre-trained smearing model, to obtain a smeared facial image corresponding to the facial image to be processed.

Herein, the smearing model is training based on a first facial image obtained without smearing the target facial organ and a second facial image obtained by smearing the target facial organ in the first facial image, herein, the second facial image is generated based on a predetermined image generating model, the image generating model being trained based on a target texture image and a target facial image.

In some embodiments of the present disclosure, the target texture image comprises a skin image obtained by performing an expanding process on a skin image in a target area in the first facial image. The target area comprises a forehead area.

In other embodiments of the present disclosure, the forehead area is determined based on a key point of an eyebrow and a key point of a forehead contour in the first facial image.

In some embodiments of the present disclosure, the target facial image is a mask of the target facial organ determined based on the target facial organ. The mask of the target facial organ is determined based on a key point of the target facial organ in the first facial image.

In some embodiments of the present disclosure, performing an expanding process on a skin image in the target area includes: performing a mirror reflection process on the skin image in the target area: and performing a stitching process on a reflected image obtained by the mirror reflection process and the skin image in the target area.

In some embodiments of the present disclosure, performing an expanding process on a skin image in the target area includes: performing a replication process on the skin image in the target area: and performing a stitching processing on a plurality of replicated images obtained from the replication process.

In some embodiments of the present disclosure, the image processing device may further include an organ extracting unit, an argon image adjusting unit and a first image addition unit.

The organ extracting unit is configured to extract a first organ image corresponding to the target facial organ in the facial image to be processed. The organ image adjusting unit is configured to adjust a shape and/or a size of the target facial organ in the first organ image to obtain a second organ image. The first image addition unit is configured to add the second organ image to the smeared facial image.

In some embodiments of the present disclosure, the image processing device may further include a second image addition unit configured to transfer a predetermined animation to the smeared facial image to obtain a dynamic image.

The apparatus provided in embodiments of the present disclosure is capable of performing the method of any embodiments in FIGS. 1-7 above in a manner similar to that of the beneficial effects, which will not be described here.

The present embodiment also provides an electronic device comprising a processor and a memory, wherein a computer program is stored in the memory, and when the computer program is executed by the processor, the method of any embodiment of FIGS. 1-7 above may be implemented.

By way of example, FIG. 9 is a schematic diagram of a structure of an electronic device in accordance with embodiments of the present disclosure. Reference is now made to FIG. 9, which shows a structural diagram suitable for the realization of the electronic device 900 in accordance with embodiments of the present disclosure. In some embodiments of the present disclosure, the electronic device 900 may include, but not limited to, mobile terminals such as mobile phones, laptop computers, digital broadcast receivers, PDA (personal digital assistant), PAD (tablet computer), PMP (portable multimedia player), on-board terminals (such as on-board navigation terminals), and fixed terminals such as digital TV, desktop computers, etc. The electronic device shown in FIG. 9 is only an example and should not impose any limitation on the functionality and scope of use of this disclosure embodiment.

As shown in FIG. 9, the electronic device 900 may include a processing device (such as a central processing unit, a graphics processor, etc.) 901 that may perform various appropriate actions and processes based on programs stored in read-only memory (ROM) 902 or loaded from storage device 908 into random access memory (RAM) 903. In RAM 903, various programs and data required for the operation of the electronic device 900 are also stored. The processing device 901, ROM 902, and RAM 903 are connected to each other via a bus 904. The input/output (I/O) interface 905 is also connected to the bus 904.

In general, the following apparatuses may be connected to the I/O interface 905: an input device 906 including. for example, a touch screen, touchpad, keyboard, mic, camera, microphone, accelerometer, gyroscope, etc.: an output device 907 including such as a liquid crystal display (LCD), speaker, vibrator, etc.: a storage device 908 including such as a magnetic tape, hard disk, etc.: and a communication device 909. The communication device 909 may allow the electronic device 900 to communicate wirelessly or wired with other devices to exchange data. Although FIG. 9 shows an electronic device 900 with various apparatuses, it is to be understood that it is not required to implement or have all of the apparatuses shown. More or fewer apparatuses may be implemented or possessed instead.

In particular, according to embodiments of the present disclosure, the process described with respect to the flow charts above may be implemented as a computer software program. For example, embodiments of the present disclosure include a computer program product that includes a computer program hosted on a non-transient computer-readable medium that contains program code for performing a method indicated in the flow chart. In such embodiments, the computer program may be downloaded and installed from a network via the communication device 909, or from the storage device 908, or from ROM 902. When the computer program is executed by the processing device 901, the above functions defined in the method of this disclosure embodiment are performed.

It is to be noted that the computer readable medium of the present disclosure may be a computer readable signal medium or a computer readable storage medium or any combination of the two. A computer readable storage medium, for example, may be, but is not limited to, an electrical, magnetic, optical, electromagnetic, infrared, or semiconductor system, apparatus, or device, or any combination of the above. More specific examples of computer readable storage media may include, but are not limited to: electrical connections having one or more wires, portable computer disks, hard disks, random access memory (RAM), read-only memory (ROM), erasable programmable read only memory (EPROM or flash memory), optical fibers, portable compact disk read only memory (CD-ROM), optical storage devices, magnetic storage devices, or any suitable combination of the above. In this disclosure, a computer-readable storage medium may be any tangible medium that contains or stores a program that may be used by or in combination with an instruction execution system, device, or device. In the present disclosure, however, a computer-readable signal medium may include a data signal propagated in a baseband or as part of a carrier that carries computer-readable program code. Such propagated data signals may take many forms, including but not limited to electromagnetic signals, optical signals, or any suitable combination of the above. A computer-readable signal medium may also be any computer-readable medium other than a computer-readable storage medium that may transmit, propagate, or transmit a program intended for use by or in combination with an instruction executing system, device or device. The program code contained on the computer readable medium may be transmitted in any appropriate medium, including but not limited to: an electrical wire, optical cable, RF (radio frequency), etc., or any suitable combination of the above.

In some embodiments, a client/server may communicate using any currently known or future developed network protocol such as HTTP (Hyper Text Transfer Protocol), and may interconnect with any form or medium of digital data communication (e.g., communication network). Examples of communication networks include a local area network (“LAN”), a wide area network (“WAN”), an internet (e.g., the Internet), and an end-to-end network (e.g., ad hoc end-to-end network), as well as any currently known or future developed networks.

The above-mentioned computer readable medium may be included in the above electronic device: or it may stand alone and not be incorporated into the electronic device.

The computer readable medium carries one or more programs, and when one or more of the programs are executed by the electronic device, cause the electronic device to: obtain a facial image to be processed: and perform a smearing process to a target facial organ in the facial image to be processed based on a pre-trained smearing model to obtain a smeared facial image corresponding to the facial image to be processed.

Computer program code for performing the operations of the disclosure may be written in one or more programming languages, or combinations thereof, including but not limited to object-oriented programming languages such as Java, Smalltalk, C++, further including conventional procedural programming languages such as the “C” language or similar programming languages. The program code may be executed entirely on the user's computer, partly on the user's computer, as a stand-alone package, partly on the user's computer and partly on a remote computer, or entirely on a remote computer or server. In the case involving a remote computer, the remote computer may be connected to the user computer over any kind of network, including a local area network (LAN) or a wide area network (WAN), or it may be connected to an external computer (e.g., using an Internet service provider to connect over the Internet).

Flow charts and block diagrams in the accompanying drawings illustrate the possible implementation of the architecture, functions, and operations of the systems, methods, and computer program products in accordance with various embodiments of the present disclosure. In this regard, each block in the flow chart or block diagram may represent a module, program segment, or part of code that contains one or more executable instructions for implementing a specified logical function. It should also be noted that in some alternate implementations, the functions indicated in the blocks may also occur in a different order than those indicated in the accompanying drawings. For example, two blocks represented one after another may actually be executed basically in parallel, or they may sometimes be executed in a reverse order, depending on the functions involved. Note also that each of the blocks in the block diagram and/or flow chart, and the combination of the blocks in the block diagram and/or flow chart, can be implemented with a dedicated hardware-based system that performs the specified function or operation. or with a combination of dedicated hardware and computer instructions.

The units referred to in the embodiments described herein may be implemented either by means of software or by means of hardware. Where the name of the unit does not in any case constitute a qualification of the unit itself.

The functions described above in this article can be performed, at least in part, by one or more hardware logical parts. For example, non-restrictively, exemplary types of hardware logic components that can be used include: a field programmable gate array (FPGA), an application-specific integrated circuit (ASIC), an application-specific standard product (ASSP), a system-on-chip (SOC), a complex programmable logic device (CPLD), and so on.

In the context of this disclosure, a machine-readable medium may be a tangible medium that may contain or store a program for use by or in conjunction with an instruction executing system, apparatus, or device. A machine-readable medium may be a machine-readable signal medium or a machine-readable storage medium. Machine-readable media may include, but are not limited to, electronic, magnetic, optical, electromagnetic, infrared, or semiconductor systems, devices, or devices, or any suitable combination of the above. More specific examples of machine-readable storage media would include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination of the above.

Embodiments of the present disclosure also provides a computer-readable storage medium in which a computer program is stored, and when the computer program is executed by a processor, the method of any of the embodiments in FIG. 1-FIG. 7 above may be implemented in a similar execution manner and with similar beneficial effect, which will not be repeated here.

It should be noted that, in this context, relational terms such as “first” and “second” are used only to distinguish one entity or operation from another and do not necessarily require or imply any such actual relationship or order between these entities or operations. Furthermore, the term “includes”, “contains”, or any other variation thereof, is intended to cover non-exclusive inclusion so that a process, method, item, or device comprising a set of elements includes not only those elements, but also other elements not expressly listed, or elements inherent to such process, method, item, or device. In the absence of further limitation, a sentence consisting of the words “includes a ... ” qualifying element does not preclude the existence of additional identical elements in a process, method, article, or device that includes the element.

The foregoing are only embodiments of the present disclosure in such a way to enable persons skilled in the art to understand or implement the present disclosure. Various modifications to these embodiments will be apparent to those skilled in the art, and the general principles defined herein may be implemented in other embodiments without deviating from the spirit or scope of this disclosure. Accordingly, the disclosure will not be limited to these embodiments described herein, and will conform to the broadest scope consistent with the principles and novel features disclosed herein.

1. A method of image processing, comprising:
obtaining a facial image to be processed; and
performing a smearing process to a target facial organ in the facial image to be processed based on a pre-trained smearing model to obtain a smeared facial image corresponding to the facial image to be processed,
wherein the smearing model is training based on a first facial image obtained without smearing the target facial organ and a second facial image obtained by smearing the target facial organ in the first facial image, wherein the second facial image is generated based on a predetermined image generating model, the image generating model being trained based on a target texture image and a target facial image.

2. The method of claim 1, wherein the target texture image comprises a skin image obtained by performing an expanding process on a skin image in a target area in the first facial image, the target area comprising a forehead area.

3. The method of claim 2, wherein the forehead area is determined based on a key point of an eyebrow and a key point of a forehead contour in the first facial image.

4. The method of claim 1, wherein the target facial image is a mask of the target facial organ determined based on the target facial organ.

5. The method of claim 4, wherein the mask of the target facial organ is determined based on a key point of the target facial organ in the first facial image.

6. The method of claim 2, wherein performing an expanding process on a skin image in the target area comprises:
performing a mirror reflection process on the skin image in the target area; and
performing a stitching process on a reflected image obtained by the mirror reflection process and the skin image in the target area.

7. The method of claim 2, wherein performing an expanding process on a skin image in the target area comprises:
performing a replication process on the skin image in the target area; and
performing a stitching processing on a plurality of replicated images obtained from the replication process.

8. The method of any of claims 1 7claim 1, wherein, after obtaining the facial image to be processed, the method further comprises:
extracting a first organ image corresponding to the target facial organ in the facial image to be processed; and
adjusting a shape and/or a size of the target facial organ in the first organ image to obtain a second organ image, and
wherein, after performing a smearing process to a target facial organ in the facial image to be processed based on a pre-trained smearing model to obtain a smeared facial image corresponding to the facial image to be processed, the method further comprises:
adding the second organ image to the smeared facial image.

9. The method of claim 1, wherein, after performing a smearing process to a target facial organ in the facial image to be processed based on a pre-trained smearing model to obtain a smeared facial image corresponding to the facial image to be processed, the method further comprises:
transferring a predetermined animation to the smeared facial image to obtain a dynamic image.

10-20. (canceled)

21. An electronic device, comprising:
a memory and a processor, wherein a computer program is stored in the memory, and the computer program when being executed by the processor, cause the processor to perform acts comprising:
obtaining a facial image to be processed; and
performing a smearing process to a target facial organ in the facial image to be processed based on a pre-trained smearing model to obtain a smeared facial image corresponding to the facial image to be processed,
wherein the smearing model is training based on a first facial image obtained without smearing the target facial organ and a second facial image obtained by smearing the target facial organ in the first facial image, wherein the second facial image is generated based on a predetermined image generating model, the image generating model being trained based on a target texture image and a target facial image.

22. The device of claim 21, wherein the target texture image comprises a skin image obtained by performing an expanding process on a skin image in a target area in the first facial image, the target area comprising a forehead area.

23. The device of claim 22, wherein the forehead area is determined based on a key point of an eyebrow and a key point of a forehead contour in the first facial image.

24. The device of claim 21, wherein the target facial image is a mask of the target facial organ determined based on the target facial organ.

25. The device of claim 24, wherein the mask of the target facial organ is determined based on a key point of the target facial organ in the first facial image.

26. The device of claim 22, wherein performing an expanding process on a skin image in the target area comprises:
performing a mirror reflection process on the skin image in the target area; and
performing a stitching process on a reflected image obtained by the mirror reflection process and the skin image in the target area.

27. The device of claim 22, wherein performing an expanding process on a skin image in the target area comprises:
performing a replication process on the skin image in the target area; and
performing a stitching processing on a plurality of replicated images obtained from the replication process.

28. The device of claim 21, wherein the acts further comprises:
extracting a first organ image corresponding to the target facial organ in the facial image to be processed;
adjusting a shape and/or a size of the target facial organ in the first organ image to obtain a second organ image; and
adding the second organ image to the smeared facial image.

29. The device of claim 21, wherein the acts further comprises:
transferring a predetermined animation to the smeared facial image to obtain a dynamic image.

30. A non-transitory computer-readable storage medium, with a computer program stored thereon, the computer program being executable by a processor to implement a method comprising:
obtaining a facial image to be processed; and
performing a smearing process to a target facial organ in the facial image to be processed based on a pre-trained smearing model to obtain a smeared facial image corresponding to the facial image to be processed,
wherein the smearing model is training based on a first facial image obtained without smearing the target facial organ and a second facial image obtained by smearing the target facial organ in the first facial image, wherein the second facial image is generated based on a predetermined image generating model, the image generating model being trained based on a target texture image and a target facial image.

31. The computer-readable storage medium of claim 30, wherein the method further comprises:
extracting a first organ image corresponding to the target facial organ in the facial image to be processed;
adjusting a shape and/or a size of the target facial organ in the first organ image to obtain a second organ image; and
adding the second organ image to the smeared facial image.
